(19) United States
(12) Patent Application Publication
(10) Pub. No.: US 2026/0262631 A1
(43) Pub. Date: Sep. 10, 2026

(54) CORNEAL STORAGE COMPOSITIONS

(71) Applicant: Aurolab Trust, Madurai (IN)

(72) Inventors: Veluchamy Venkatesa Kannan, Madurai (IN); Annamalai Karpagam, Madurai (IN); Namperumalsamy Venkatesh Prajna, Madurai (IN)

(21) Appl. No.: 19/661,788

(22) Filed: Apr. 29, 2026

Related U.S. Application Data
(63) Continuation-in-part of application No. 18/473,394, filed on Sep. 25, 2023.
(60) Provisional application No. 63/409,889, filed on Sep. 26, 2022.

(51) Int. Cl. A01N 1/124; A01N 1/126

(52) U.S. Cl. CPC A01N 1/124; A01N 1/126

(57) ABSTRACT

The present invention is related to corneal storage compositions comprising moxifloxacin and amphotericin B. The present invention is further directed to methods of storing viable corneal tissue comprising placing viable corneal tissue in a composition of the present invention.

### FIELD OF THE INVENTION

The present invention is related to corneal storage compositions comprising moxifloxacin and amphotericin B. The present invention is further directed to methods of storing viable corneal tissue comprising placing viable corneal tissue in a composition of the present invention.

### BACKGROUND OF THE INVENTION

Corneal damage is one of the major causes of blindness throughout the world. There are between one to two million new cases of blindness each year due to corneal damage. The cornea is the transparent tissue that covers the front of the eye. The cornea is important in bringing images into focus and if damaged can block light from reaching the retina. The cornea may become damaged via disease, injury and/or infection of the corneal tissue. While the cornea may repair itself after minor injuries or infections, it is unable to do so for more severe injuries or infections and many diseases.

Restoring corneal tissue is one of the only options for restoring eyesight in an eye that has incurred corneal damage too severe for self-repair. Due to the slow proliferation of corneal tissue, corneal repair requires a whole viable cornea. Whole corneas are stored in cornea banks until such time as they are ready to be transplanted to a donor eye. Several methods have been developed for storage of these corneas including cryopreservation, hypothermia and organ culture. However, none of these techniques are completely effective in maintaining a viable cornea that can be grafted onto a donor eye without complication. Despite the prevalence of corneal storage banks and techniques, common complications such as bacterial and fungal contamination continue to occur.

Thus, there is a need in the art for further techniques and corneal storage compositions that reduce complications including contamination.

### SUMMARY OF THE INVENTION

In one aspect, the present invention is directed to a corneal storage composition comprising moxifloxacin and amphotericin B.

In another aspect, the present invention is directed to a method of storing viable corneal tissue comprising placing viable corneal tissue in a composition comprising moxifloxacin and amphotericin B.

### DETAILED DESCRIPTION OF THE INVENTION

The Applicant has discovered a corneal storage composition that has unexpectedly superior preservation capability compared to that of the prior art.

In one embodiment, the present invention is directed to a corneal storage composition comprising moxifloxacin.

In another embodiment, the present invention is directed to a corneal storage composition comprising moxifloxacin and amphotericin B.

In a preferred embodiment, moxifloxacin is present in compositions of the present invention at a concentration from about 0.0025% to about 0.5% w/v.

In another preferred embodiment, amphotericin B is present in compositions of the present invention at a concentration from about 0.0001% to about 0.001% w/v.

In another preferred embodiment, compositions of the present invention may further comprise one or more excipients selected from the group consisting of chondroitin sulfate, a dextran, L-alanyl-L-glutamine dipeptide, vitamin B-12.

In a more preferred embodiment, chondroitin sulphate may be present in compositions of the present invention at a concentration from about 1% to about 4% w/v.

Dextrans suitable for use in the present invention include, but are not limited to, dextrans having a molecular weight of from about 10 to about 1,000 Daltons, preferably from about 40 to about 500 Daltons. In a preferred embodiment, the dextran is selected from the group consisting of a dextran having a molecular weight of about 40 (“dextran 40”), about 70 (“dextran 70”) and about 500 Daltons (“dextran 500”). In a preferred embodiment, a dextran may be present in compositions of the present invention at a concentration from about 0.5% to about 10% w/v, more preferably from about 1% to about 5% w/v.

In another more preferred embodiment, L-alanyl-L-glutamine dipeptide may be present in compositions of the present invention at a concentration from about 0.1% to about 3% v/v.

In another more preferred embodiment, vitamin B-12 may be present in compositions of the present invention at a concentration from about 0.00001% to about 0.001% w/v.

Composition of the present invention may further comprise recombinant human insulin. In a preferred embodiment, recombinant human insulin may be present in compositions of the present invention at a concentration from about 0.00001% to about 0.001% v/v.

In another preferred embodiment, compositions of the present invention may further comprise one or more excipients selected from the group consisting of glucose, amino acids, N-2-hydroxyethyl piperazine N-2-ethane sulphonic acid, sodium bicarbonate, minimum essential medium, medium 199 and sodium pyruvate.

In a more preferred embodiment, the present invention is directed to a corneal storage composition comprising:
from about 0.0025% to about 0.5% w/v moxifloxacin;
from about 1% to about 4% w/v chondroitin sulphate;
from about 0.5% to about 10% w/v of a dextran;
from about 0.1% to about 3% v/v L-alanyl-L-glutamine dipeptide; and
from about 0.00001% to about 0.001% w/v vitamin B-12, and
optionally, comprising:
from about 0.3% to about 1.5% w/v N-2-hydroxyethyl piperazine N-2-ethane sulphonic acid; and
from about 0.01% to about 0.5% w/v sodium pyruvate.

In a more preferred embodiment, the present invention is directed to a corneal storage composition comprising:
about 0.025% w/v moxifloxacin;
about 2.5% w/v chondroitin sulphate;
about 1.0% w/v dextran-40;
about 0.8% or about 1.0% w/v L-alanyl-L-glutamine dipeptide;
about 0.000136% v/v vitamin B-12; and
about 0.0006% v/v recombinant human insulin and optionally comprising:
about 0.8% w/v N-2-hydroxyethyl piperazine N-2-ethane sulphonic acid;
about 0.111% w/v sodium pyruvate;
about 0.4% w/v minimum essential medium; and
about 0.15% w/v medium 199.

In a more preferred embodiment, the present invention is directed to a corneal storage composition comprising:
about 0.025% w/v moxifloxacin;
about 0.00025% w/v amphotericin B;
about 2.5% w/v chondroitin sulphate;
about 1.0% w/v dextran-40;
about 0.8% or about 1.0% w/v L-alanyl-L-glutamine dipeptide;
about 0.000136% v/v vitamin B-12; and
about 0.0006% v/v recombinant human insulin; and optionally comprising:
about 0.8% w/v N-2-hydroxyethyl piperazine N-2-ethane sulphonic acid;
about 0.111% w/v sodium pyruvate;
about 0.4% w/v minimum essential medium; and
about 0.15% w/v medium 199.

In another more preferred embodiment, the present invention is directed to a corneal storage composition comprising:
about 0.025% w/v moxifloxacin;
about 0.00025% w/v amphotericin B;
about 2.5% w/v chondroitin sulphate;
about 4.5% w/v dextran 500;
about 1.0% v/v L-alanyl-L-glutamine dipeptide; and
about 0.000136% v/v vitamin B-12;
and optionally comprising:
about 0.8% w/v N-2-hydroxyethyl piperazine N-2-ethane sulphonic acid;
about 0.15% w/v sodium bicarbonate;
about 0.00015% v/v phenol red indicator;
about 0.111% w/v sodium pyruvate;
about 0.4% w/v minimum essential medium; and
about 0.15% w/v medium 199; and
purified water.

Compositions of the present invention may be in the form of a solution, a suspension or an aqueous emulsion.

In another embodiment, the present invention is further directed to a method of storing viable corneal tissue comprising placing viable corneal tissue in a composition of the present invention.

As used herein the term “moxifloxacin hydrochloride” refers to a compound having the CAS #151096-09-2 and the following chemical structure:

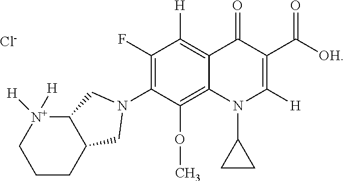 [SMILES: [Cl-] ; COc1c(N2C[C@@H]3CCC[NH2+][C@@H]3C2)c(F)cc2c(=O)c(C(=O)O)cn(C3CC3)c12]

As used herein the term “amphotericin B” refers to a compound having the CAS #1397-89-3 and the following chemical structure:

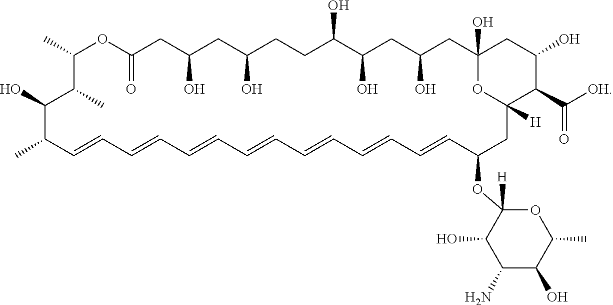 [SMILES: C[C@@H]1[C@H](O)[C@@H](C)/C=C/C=C/C=C/C=C/C=C/C=C/C=C/[C@H](O[C@@H]2O[C@H](C)[C@@H](O)[C@H](N)[C@@H]2O)C[C@@H]2O[C@](O)(C[C@@H](O)C[C@@H](O)[C@H](O)CC[C@@H](O)C[C@@H](O)CC(=O)O[C@H]1C)C[C@H](O)[C@H]2C(=O)O]

As used herein, “composition” refers to one or more active ingredients in a carrier.

Throughout the application, the singular forms “a,” “an,” and “the” include plural reference unless the context clearly dictates otherwise.

Throughout the application, all disclosed ranges include all possible values within those ranges. All possible values within the ranges disclosed in the application can also be used as endpoints for additional ranges between these values.

As used herein, all numerical values relating to amounts, weights, and the like, are defined as “about” each particular value, that is, plus or minus 10%. For example, the phrase “10% w/w” is to be understood as “9% to 11% w/w.” Therefore, amounts within 10% of the claimed value are encompassed by the scope of the claims.

As used herein “% w/v” refers to the weight percent by total volume of the formulation.

As used herein “% v/v” refers to the volume percent by total volume of the formulation.

The invention is demonstrated by the following representative examples. These examples are offered by way of illustration only and not by way of limitation.

### EXAMPLES

### Example 1—Microbial Activity Reduction

TABLE 1

| Formulation | Cornisol ™ | Formulation #1 | Formulation #2 |
|---|---|---|---|
| Chondroitin sulphate | 2.5% | 2.5% | 2.5% |
| Dextran-40 | 1.0% | 1.0% | 1.0% |
| HEPES Buffer (N-2- | 0.8% | 0.8% | 0.8% |
| hydroxyethyl | | | |
| piperazine N-2-ethane | | | |
| sulphonic acid) | | | |
| Sodium pyruvate | 0.111% | 0.111% | 0.111% |
| Gentamicin sulfate | 0.01% | — | — |
| Streptomycin sulfate | 0.02% | — | — |
| Moxifloxacin HCl | — | 0.025% | 0.025% |
| Amphotericin B | — | — | 0.00025% |
| (0.005% w/v) | | | |
| Sodium bicarbonate | 0.25% | 0.25% | 0.25% |
| Minimum essential | 0.4% | 0.4% | 0.4% |
| medium | | | |
| Medium-199 | 0.15% | 0.15% | 0.15% |
| Glutamax-I 200 mM | 1.0% | 1.0% | 1.0% |
| Solution | | | |
| Vitamin B-12 | 0.000136% | 0.000136% | 0.000136% |
| (0.1% w/v) | | | |
| Recombinant human | 0.0006% | 0.0006% | 0.0006% |
| insulin (0.1% v/v) | | | |
| Phenol red indicator | 0.00015% | 0.00015% | 0.00015% |
| (0.2% v/v) | | | |
| Sterile Water | Q. S. | Q. S. | Q. S. |

Minimum essential medium contains calcium chloride, magnesium sulfate, potassium chloride, sodium chloride, sodium phosphate monobasic, L-arginine hydrochloride, L-cysteine dihydrochloride, L-glutamine, L-histidine hydrochloride monohydrate, L-isoleucine, L-leucine, L-lysine hydrochloride, L-methionine, L-phenylalanine, L-threonine, L-tryptophan, L-tyrosine disodium dihydrate, L-valine, choline chloride, folic acid, myo-inositol, niacinamide, D-pantothenic acid, pyridoxal hydrochloride, riboflavin, thiamine hydrochloride, glucose and sodium bicarbonate.

Medium 199 contains, in addition to those components of minimum essential medium, adenine, adenosine, hypoxanthine and thymine.

Glutamax-I™ is an L-alanyl-L-glutamine dipeptide.

Vitamin B12 (CAS #68-19-9) is also known as cobalamin.

Dextran 40 has the CAS #9004-54-0.

### Method

6 bacterial organisms (Staphylococcus aureus, Acinetobacter sp., Klebsiella sp., Proteus sp., Psuedomonas aeruginosa and Coagulase negative Staphylococcus sp.) were isolated from a cultured bacterial keratitis and incubated at a temperature from 30 to 35 degrees Celsius for 18 to 24 hours on tryptic soy agar. Further, 5 fungal organisms (Aspergillus niger, Aspergillus terreus, Candida sp., Mucor sp. and Fusarium sp.) were isolated from a cultured fungal keratitis and incubated at 20 to 25 degrees Celsius for 24 to 120 hours until good sporulation was obtained.

Bacterial cultures and C. albicans were harvested using a 0.9% w/v sodium chloride solution containing 0.1% w/v peptone and diluted to a microbial count of about 1×10⁸ organisms per milliliter. A. niger was isolated using a 0.9% w/v sodium chloride solution containing 0.05% w/v polysorbate 80 and diluted to a microbial count of about 1×10⁸ organisms per milliliter.

Cultures were then inoculated with Cornisol, Formulation #1 or Formulation #2 from Table 1, above, and incubated at 20 to 25 degrees Celsius for fungal growth and 30 to 35 degrees Celsius for bacterial growth. Results of this study can be found in Tables 2 and 3, below.

TABLE 2

| | | Cornisol ™ | | | | Formulation #1 | | | | Formulation #2 | | | |
|---|---|---|---|---|---|---|---|---|---|---|---|---|---|
| | | Days Post Inoculation | | | | Days Post Inoculation | | | | Days Post Inoculation | | | |
| Bacterial | Formula | 1 | 7 | 14 | 28 | 1 | 7 | 14 | 28 | 1 | 7 | 14 | 28 |
| Organism | Initial | Log Reduction | | | | Log Reduction | | | | Log Reduction | | | |
| S. aureus | 6 × 10⁵ | <3.3 | <3.3 | <3.3 | <3.3 | 4.8 | 4.8 | 4.8 | 4.8 | 4.8 | 4.8 | 4.8 | 4.8 |
| Acinetobacter | 3 × 10⁶ | <4 | <4 | <4 | <4 | 5.5 | 5.5 | 5.5 | 5.5 | 5.5 | 5.5 | 5.5 | 5.5 |
| sp. | | | | | | | | | | | | | |
| Klebsiella sp. | 2 × 10⁵ | <2.8 | <2.8 | <2.8 | <2.8 | 3.3 | 4.3 | 4.3 | 4.3 | 3.3 | 4.3 | 4.3 | 4.3 |
| Proteus sp. | 3.1 × 10⁵ | <3 | <3 | <3 | <3 | 3.2 | 4.5 | 4.5 | 4.5 | 3.2 | 5.5 | 5.5 | 5.5 |
| P. aeruginosa | 1.5 × 10⁵ | 4.2 | 3.6 | <2.7 | <2.7 | 4.2 | 4.2 | 4.2 | 4.2 | 4.2 | 4.2 | 4.2 | 4.2 |
| Coagulase (−) | 3.4 × 10⁵ | 4.4 | 4.4 | 4.4 | 4.4 | 4.5 | 4.5 | 4.5 | 4.5 | 4.5 | 4.5 | 4.5 | 4.5 |
| Staphylococcus | | | | | | | | | | | | | |

TABLE 3

| | | Cornisol ™ | | | | Formulation #1 | | | | Formulation #2 | | | |
|---|---|---|---|---|---|---|---|---|---|---|---|---|---|
| | | Days Post Inoculation | | | | Days Post Inoculation | | | | Days Post Inoculation | | | |
| Fungal | Formula | 1 | 7 | 14 | 28 | 1 | 7 | 14 | 28 | 1 | 7 | 14 | 28 |
| Organism | Initial | Log Reduction | | | | Log Reduction | | | | Log Reduction | | | |
| A. niger | 6.8 × 10⁵ | 3.8 | <3.3 | <3.3 | <3.3 | 3.9 | <3 | <3 | <3 | 4.1 | 4.5 | 4.5 | 4.5 |
| A. terreus | 5 × 10⁵ | 4.3 | 3.5 | <3.5 | <3.5 | 1.4 | <3 | <3 | <3 | 4.7 | 4.7 | 4.7 | 3.9 |
| Candida sp. | 3.2 × 10⁵ | <3 | <3 | <3 | <3 | 3 | <3 | <3 | <3 | 3.1 | 3.6 | <3 | <3 |
| Mucor sp. | 6.2 × 10⁵ | 4 | <3 | <3 | <3 | 4.1 | <3 | <3 | <3 | 4.8 | 4.8 | 4.8 | 4.8 |
| Fusarium sp. | 6.2 × 10⁵ | 4 | <3.3 | <3.3 | <3.3 | 4.8 | 4.1 | 3.3 | 3.3 | 4.8 | 4.8 | <3.3 | <3.3 |

### Results

As demonstrated in Table 2, the use of each of Formulation #1 and #2 resulted in a greater reduction in bacterial load than that of Cornisol™. This result was true for each of the bacterial organisms tested. Specifically, for S. aureus the use of Formulations #1 and #2 resulted in a 4.8 log reduction in bacterial load as compared to less than 3.3 log reduction when Cornisol™ was used. This is a 15-fold reduction in the amount of S. aureus. The use of Formulations #1 and #2 also resulted in a 15-fold reduction in Acinetobacter sp., Klebsiella sp., Proteus sp. and P. aeruginosa as compared to Cornisol™.

As demonstrated in Table 3, the use of Formulation #2 resulted in greater reduction in fungal load than that of Cornisol™. Specifically, the use of Formulation #2 resulted 12-fold reduction in A. niger and A. terreus, a 6-fold reduction in Candid sp. and a 15-fold reduction in Mucur sp. and Fusarium sp. as compared to Cornisol™.

Thus, Formulations #1 and #2 are superior corneal storage solutions than Cornisol™ as each of Formulations #1 and #2 dramatically reduce the bacterial load and Formulation #2 dramatically reduces the fungal load as compared to Cornisol™.

### Example 2—Skin Sensitization Study

A study was conducted from Aug. 14, 2018 to Dec. 4, 2018 to determine skin sensitization in Guinea pigs as per the ISO 10993 “Biological Evaluation of Medical Devices”—Part 10:2010(E).

The study comprised of two groups, G1 contained 5 guinea pigs and were subjected to contact with a vehicle control and G2 contained 10 guinea pigs and were subjected to Formulation #2 from Table 1, above. The study included an intradermal injection on day 1, topical induction on day 8 and challenge on day 22. Fur from the designated sites for respective phases of the experiment was clipped closely using an electric hair clipper approximately 24 hours prior to initiation of the treatment.

On day 1, the animals were injected at the shoulder region with 0.1 mL per injection of 3 pairs of intradermal injections. Post intradermal induction at site 2, of Formulation #2 from Table 1, above, did not reveal any skin reactions at 24+/−2 and 48+/−2 hours of observation. Hence, on day 7, intra-dermal induction sites of all the animals were treated (clipped area) with 0.5 mL of 10% w/w Sodium Lauryl Sulphate in Vaseline to produce local irritation.

On day 8, the filter paper (2 cm×4 cm) was saturated by soaking in vehicle control and Formulation #2 from Table 1, above, applied topically to G1 and G2 group animals respectively. The patch was held in place with non-irritating adhesive tape and further wrapped with crepe bandage by an occlusive dressing. The test patch was held in its position for 48+/−2 hours. After 48+/−2 hours of contact period the test patch was removed, and the area was cleaned with normal saline swabs and dried with cotton. The skin reactions were observed at 1 and 24 hours of post removal of the test patch. The animals did not reveal any skin reactions.

Similarly on day 22, the filter paper was saturated by soaking in the respective vehicle control and Formulation #2 from Table 1, above, applied on to the respective groups over the pre-clipped area. Formulation #2 from Table 1, above, was applied on the posterior part of right flank region and control was applied on the anterior part of right flank region for G1 and G2 groups respectively. The test patch was held in its position for 24+/−2 hours. After 24+/−2 hours of contact period, the test patches were removed, and the area was cleaned with normal saline swabs and dried with absorbent cotton. The skin reactions were observed at 24+/−2 and 48+/−2 hours of post removal of the test patch. The animals did not reveal any skin reactions.

All animals were observed once daily for clinical signs of toxicity and twice daily for mortality. Body weight was recorded at receipt, prior to initiation of the treatment (day 1) and at termination. The animals did not reveal any clinical signs of toxicity or mortality. There were no treatment related variations in mean body weight and percent change in body weight with respect to day 1.

After completion of observation period, all animals were sacrificed under carbon dioxide anesthesia and subjected to necropsy and complete gross pathological examination. There were no gross pathological changes observed.

### Conclusion

Based on the above results of the experiment, it is concluded that Formulation #2 from Table 1, above, is a “non-sensitizer” to the skin of the Guinea pigs under the experimental conditions employed.

### Example 3—Acute Ocular Irritation Study

A study was conducted from Aug. 14, 2018 to Dec. 3, 2018 to determine ocular irritation in New Zealand white rabbits as per the ISO 10993 “Biological Evaluation of Medical Devices”—Part 10:2010(E).

The study was performed in two phases, initial test and confirmatory test. Before initiating the treatment, the ocular abnormalities of the selected experimental animals were examined within 24 hours using ophthalmoscope for initial test animal and confirmatory test animals. Only the animals with absence of signs of eye irritation, ocular defects, or pre-existing corneal injury were used.

The initial test was conducted using single female rabbit and confirmatory test was conducted with two female rabbits. The right eye was untreated and served as reference control. 0.1 mL of Formulation #2 from Table 1, above, was instilled into lower conjunctival sac of the left eye.

All animals were observed once daily for clinical signs and twice daily for mortality up to the day of termination. The scoring of ocular reaction of each animal was done at 1 hr (+/−6 minutes), 24 hrs (+/−2), 48 hrs (+/−2) and 72 hrs (+/−2) hours after instillation. Body weight was recorded at receipt, on the day of instillation (Day 1) and at termination (Day 4). After 72 hours observation, all animals was sacrificed using sodium thiopentone by intravenous administration, subjected to necropsy and complete gross pathological examination.

No treatment related clinical signs of toxicity and mortality was observed in initial test animal and confirmatory test animals after instillation. No treatment related ocular lesions were observed up to 72 hours in initial test animal and confirmatory test animals after instillation. No treatment related changes were observed in body weight and percent change in body weight with respect to day 1 in all the animals in initial test and confirmatory test. No gross pathological changes were observed in any of the animals in initial test and confirmatory test.

### Conclusion

Based on the above results of the experiment, it is concluded that Formulation #2 from Table 1, above, did not produce any irritant effects to the eyes of New Zealand White Rabbits under the experimental conditions employed.

### Example 4—In Vitro Cytotoxicity Study

A study was conducted from Aug. 23, 2018 to Oct. 5, 2018 to determine cytotoxicity of Formulation #2 from Table 1, above, as per the International Organization for Standardization (ISO) guideline no. 10993: “Biological Evaluation of Medical Devices”-Part 5 and as per “Biological Evaluation of Medical Devices-Part 12:2012(E): Sample preparation and reference materials”. International Standard (ISO) 10993-5, Third edition 2009 Jun. 1, “Biological Evaluation of Medical Devices-Part 5-Test for in vitro cytotoxicity”.

L-929 mouse fibroblast cells were seeded in 6 well plates and wells with subconfluent monolayer were selected for treatment. The growth medium in each well was replaced with 2 mL of an agarose mixture. The agarose mixture was allowed to solidify over the cells to form an agarose overlay. All the treatments were maintained in triplicates. Filter discs saturated with Formulation #2 from Table 1, above, were placed on solidified agarose layer covering approximately 1/10th of well diameter. Similarly filter discs saturated with normal saline were placed on solidified agarose layer covering approximately 1/10th of the cell layer surface. Further, high density polyethylene sheets (i.e. negative control) and ZDEC polyurethane sheet (i.e. positive control) covering approximately 1/10th of the cell layer surface. Blank wells were maintained without any treatment.

The cells were incubated at 37+/−1° C. in the presence of 5+/−1% CO₂ and the cultures were examined microscopically at 26, 48 and 72 hours post treatment to evaluate the changes in cell morphology and cell lysis.

At 26, 48 and 72 hours post treatment, application of Formulation #2 resulted in no detectable zone around or under the specimen (Grade 0), (i.e. no reactivity). Cells in the blank, filter disc control and negative control showed no reactivity with no detectable zone around or under the specimen (Grade 0). At 26, 48 and 72 hours post treatment, the positive control showed severe reactivity (Grade 4) with evidence of zone extending specimen size up to 1.0 cm.

### Conclusion

Based on the above results of the experiment, it is concluded that Formulation #2 from Table 1, above, is non-cytotoxic to the subconfluent monolayer of L-929 mouse fibroblast cells under the experimental conditions employed.

### Example 5—In Vivo Efficacy Study

A study was conducted to determine the efficacy of Formulation #2 from Table 1, above, in preventing growth of microbials on corneal tissue during storage. The study was conducted at Aravind Eye Hospital. 46 eyes were enucleated from donors and cornea with sclera was removed. Immediately following recovery, all ocular tissue were placed in a temporary EBAI Thermacole box and transported in cooler for transport to the eye bank. Excision of the cornea was performed in a laminar flow hood and grasp, cornea at the scleral rim were removed from the eye by using excision instrument. The same procedure was used for transferring each cornea. The cornea with sclera rim was washed with saline solution and it was placed in an SS sterile Cup. The above processed corneas were then transferred into bottles containing Formulation #2 from Table 1, above, and stored at 2-8° C. for either 1, 2, 3, 4 or 5 days.

Following either 1, 2, 3, 4 and 5 days of storage in Formulation #2 from Table 1, above, bottles were transferred to 37° C. for 2 hours. Following the 2-hour incubation period, 100 microliters was taken from each bottle and spread on a Blood Agar plate and incubated at 37° C. for 24 to 48 hours to promote bacterial growth and at 22° C. for 120 to 168 hours to promote fungal growth.

No growth was seen in any of the Blood Agar plates inoculated with the medium from bottles containing corneas in Formulation #2 from Table 1, above. Thus, the corneal storage compositions of the present invention significantly prevent wide range of bacterial contaminants and fungal contaminants during storage period.

### Example 6—In Vivo Efficacy Study (Prophetic)

A study was conducted to determine the efficacy of Formulation #1 from Table 1, above, in preventing growth of microbials on corneal tissue during storage. The study was conducted at Aravind Eye Hospital. 46 eyes were enucleated from donors and cornea with sclera was removed. Immediately following recovery, all ocular tissue were placed in a temporary EBAI Thermacole box and transported in cooler for transport to the eye bank. Excision of the cornea was performed in a laminar flow hood and grasp, cornea at the scleral rim were removed from the eye by using excision instrument. The same procedure was used for transferring each cornea. The cornea with sclera rim was washed with saline solution and it was placed in an SS sterile Cup. The above processed corneas were then transferred into bottles containing Formulation #2 from Table 1, above, and stored at 2-8° C. for either 1, 2, 3, 4 or 5 days.

Following either 1, 2, 3, 4 and 5 days of storage in Formulation #1 from Table 1, above, bottles were transferred to 37° C. for 2 hours. Following the 2-hour incubation period, 100 microliters was taken from each bottle and spread on a Blood Agar plate and incubated at 37° C. for 24 to 48 hours to promote bacterial growth.

No growth was seen in any of the Blood Agar plates inoculated with the medium from bottles containing corneas in Formulation #1 from Table 1, above. Thus, the corneal storage compositions of the present invention significantly prevent wide range of bacterial contaminants.

What is claimed is:

1. A corneal storage composition comprising moxifloxacin and amphotericin B.

2. The corneal storage composition of claim 1, wherein moxifloxacin is at a concentration of from about 0.0025% to about 0.5% w/v, wherein w/v denotes weight by total volume of the composition.

3. The corneal storage composition of claim 1, wherein amphotericin B is at a concentration of from about 0.00001% to about 0.001% w/v, wherein w/v denotes weight by total volume of the composition.

4. The corneal storage composition of claim 1, further comprising one or more excipients selected from the group consisting of chondroitin sulfate, a dextran, L-alanyl-L-glutamine dipeptide and vitamin B-12.

5. The corneal storage composition of claim 4, wherein the dextran has a molecular weight from about 10 to about 1,000 Daltons.

6. The corneal storage composition of claim 5, wherein the dextran has a molecular weight from about 40 to about 500 Daltons.

7. The corneal storage composition of claim 6, wherein the dextran is selected from the group consisting of dextran 40, dextran 70 and dextran 500.

8. The corneal storage composition of claim 4, further comprising one or more excipients selected from the group consisting of glucose, amino acids, N-2-hydroxyethyl piperazine N-2-ethane sulphonic acid, sodium bicarbonate, minimum essential medium, medium 199 and sodium pyruvate.

9. A corneal storage composition comprising:
from about 0.0025% to about 0.5% w/v moxifloxacin;
from about 1% to about 4% w/v chondroitin sulphate;
from about 0.5% to about 10% w/v of a dextran;
from about 0.1% to about 3% v/v L-alanyl-L-glutamine dipeptide; and
from about 0.00001% to about 0.001% w/v vitamin B-12,
wherein w/v denotes weight by total volume of the composition and v/v denotes volume by total volume of the composition.

10. The corneal storage composition of claim 9, further comprising:
from about 0.3% to about 1.5% w/v N-2-hydroxyethyl piperazine N-2-ethane sulphonic acid; and
from about 0.01% to about 0.5% w/v sodium pyruvate.

11. The corneal storage composition of claim 10, further comprising one or more excipients selected from the group consisting of glucose, amino acids, sodium bicarbonate, minimum essential medium and medium 199.

12. A corneal storage composition comprising:
about 0.025% w/v moxifloxacin;
about 0.00025% w/v amphotericin B;
about 2.5% w/v chondroitin sulphate;
about 4.5% w/v dextran 500;
about 1.0% v/v L-alanyl-L-glutamine dipeptide; and
about 0.000136% v/v vitamin B-12,
wherein w/v denotes weight by total volume of the composition and v/v denotes volume by total volume of the composition.

13. The corneal storage composition of claim 12, further comprising:
about 0.8% w/v N-2-hydroxyethyl piperazine N-2-ethane sulphonic acid;
about 0.15% w/v sodium bicarbonate;
about 0.00015% v/v phenol red indicator;
about 0.111% w/v sodium pyruvate;
about 0.4% w/v minimum essential medium; and
about 0.15% w/v medium 199.

14. A method of storing viable corneal tissue comprising placing viable corneal tissue in a composition comprising moxifloxacin and amphotericin B.

15. The method of claim 14, wherein moxifloxacin is at a concentration of from about 0.0025% to about 0.5% w/v, wherein w/v denotes weight by total volume of the composition.

16. The method of claim 14, wherein amphotericin B is at a concentration of from about 0.00001% to about 0.001% w/v, wherein w/v denotes weight by total volume of the composition.

17. The method of claim 14, wherein the composition further comprises one or more excipients selected from the group consisting of chondroitin sulfate, a dextran, L-alanyl-L-glutamine dipeptide and vitamin B-12.

18. The method of claim 14, wherein the composition further comprises one or more excipients selected from the group consisting of glucose, amino acids, N-2-hydroxyethyl piperazine N-2-ethane sulphonic acid, sodium bicarbonate, minimum essential medium, medium 199 and sodium pyruvate.
